(19) United States
(12) Patent Application Publication
(10) Pub. No.: US 2018/0218399 A1
(43) Pub. Date: Aug. 2, 2018

(54) GENERATING A CONTENT ITEM FOR PRESENTATION TO AN ONLINE SYSTEM USER INCLUDING CONTENT DESCRIBING A PRODUCT SELECTED BY THE ONLINE SYSTEM BASED ON LIKELIHOODS OF USER INTERACTION

(71) Applicant: Facebook, Inc., Menlo Park, CA (US)

(72) Inventors: Shyamsundar Rajaram, San Francisco, CA (US); Pradheep K. Elango, Mountain View, CA (US); Yanxi Pan, Fremont, CA (US); Apurva Jadhav, Mountain View, CA (US)

(21) Appl. No.: 15/422,187

(22) Filed: Feb. 1, 2017

(51) Int. Cl. G06Q 30/02

(52) U.S. Cl. CPC G06Q 30/0255

(57) ABSTRACT

An online system generates a content item for a user based on products likely to be of interest to the user. The online system receives information about content provided by one or more third party systems the user accessed and determines products associated with accessed content. When the online system identifies an opportunity to present to a user, the online system retrieves products maintained by the online system and identifies candidate products for inclusion in the content item based on relevance of the products to the user. The online system determines probabilities of the user accessing the content item including different candidate products and removes combinations of the content item and candidate products having less than a threshold probability of user interaction. The online system includes one or more combinations of the content item and candidate products in one or more selection processes selecting content for presentation to the user.

### BACKGROUND

This disclosure relates generally to presenting content to users of an online system, and more specifically to generating a content item including content describing a product selected by the online system for presentation to the user.

Online systems, such as social networking systems, allow users to connect to and to communicate with other users of the online system. Users may create profiles on an online system that are tied to their identities and include information about the users, such as interests and demographic information. The users may be individuals or entities such as corporations or charities. Online systems allow users to easily communicate and to share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow publishing users (e.g., businesses) to sponsor presentation of content on an online system to gain public attention for a user's products or services or to persuade other users to take an action regarding the publishing user's products or services. Content for which the online system receives compensation in exchange for presenting to users is referred to as “sponsored content.” Many online systems receive compensation from a publishing user for presenting online system users with certain types of sponsored content provided by the publishing user. Frequently, online systems charge a publishing user for each presentation of sponsored content to an online system user or for each interaction with sponsored content by an online system user. For example, an online system receives compensation from a publishing user each time a content item provided by the publishing user is displayed to another user on the online system or each time another user is presented with a content item on the online system and interacts with the content item (e.g., selects a link included in the content item), or each time another user performs another action after being presented with the content item.

Various publishing users or third party systems may provide the online system with content items identifying products associated with the publishing users or third party systems, such as products a publishing user or a third party system offers for sale. However, different users may have varying levels of interest in different products associated with a publishing user or a third party system. For example, if various products are offered for sale by a publishing user, if the publishing user selects content about a particular product for inclusion in a content item, users who are uninterested in the particular product may be less inclined to view or to interact with the content item. In the preceding example, if information about an alternative product were included in the content item, different users may be more inclined to view or to otherwise interact with the content item. While a publishing user generating multiple content items including content describing different products and providing the multiple content items to the online system for presentation may increase a number of online system users who view or who interact with content items provided by the publishing user to the online system, generating and maintaining a large number of content items consumes significant resources of and time of a publishing user.

### SUMMARY

An online system receives a content item for presentation to one or more users of the online system that includes a creative presenting content from an application that includes a product. The content item is received from a third party system or is otherwise associated with a third party system. For example, the creative includes information describing the product or information from the application for purchasing the product. The product included in the content item may be any good or service associated with the third party system. Example products include: travel offers (e.g., hotel reservations, flight reservations, real estate listings, media (e.g., video, audio) offered for sale or for use, physical goods, services provided by the third party system, or any other item associated with the third party system. To increase a likelihood of users interacting with the content item when it is presented, the content item includes instructions that cause the online system to select the product included in the creative and to generate the creative for the content item including the selected product. Hence, rather than identify specific content that is presented to each user to whom the content item is presented, the instructions included in the content item allow the online system to dynamically identify the product presented by the creative for different users.

Additionally, the online system receives information identifying content provided by various third party systems accessed by a user. In various embodiments, content provided by different third party systems includes information describing products associated with or provided by a third party system, and the online system receives information identifying products described by content from the third party system accessed by the user. For example, a third party system includes a tracking mechanism in content presented to users. The tracking mechanism comprises instructions that, when executed by a client device presenting the content, obtain information identifying one or more products included in the content and information identifying the user to the online system; execution of the instructions comprising the tracking mechanism further causes the client device to communicate the information identifying the one or more products and identifying the user to the online system. In various embodiments, the tracking mechanism may communicate additional information to the online system describing interaction with the content by the user of the online system. For example, the tracking mechanism communicates information describing one or more interactions by the user with various portions of the presented content corresponding to an identified product to the online system.

Various third party systems also provide the online system with information describing products associated with or provided by the third party systems. For example, a third party system provides the online system with a catalog including product identifiers used by the third party system for various products. The catalog also includes characteristics associated with different products by the third party system. For example, the catalog includes a product identifier associated with a product by the third party system as well as a title, a description, one or more keywords, and any other suitable information associated with the product identifier. Different third party systems may provide the online system with different characteristics associated with products.

When the online system identifies an opportunity to present one or more content items to the user, the online system ranks products associated with the third party system based on characteristics of the products associated with the third party system and characteristics of products previously accessed by the user. In various embodiments, based on characteristics of the products associated with the third party system, characteristics of products previously accessed by the user, and interactions by the user with content associated with products accessed by the user, the online system determines likelihoods of the user interacting with content including information describing different products associated with the third party system. Based on the likelihoods of interaction, the online system ranks products associated with the third party system.

In some embodiments, the online system ranks products associated with the third party system along with products associated with other third party systems, generating a ranking that includes products associated with different third party systems. For example, the online system ranks products associated with all third party systems that provided the online system with information describing products, generating a unified product ranking that includes products associated with multiple third party systems. Hence, the unified product ranking organizes products that multiple third party systems have identified to the online system ranked based on likelihoods of the user interacting with content describing various products. To rank the products, the online system may apply one or more models to characteristics of products associated with the third party system (or associated with other third party systems), to characteristics of the user, and to characteristics of products previously accessed by the user to determine likelihoods of the user interacting with content that describes different products. For example, the online system compares characteristics of products associated with one or more third party systems accessed by the user to characteristics of products associated with the third party system and ranks products based on amounts (e.g., a number, a percentage) of characteristics of products matching characteristics of products previously accessed by the user. For example, the online system determines products included in content accessed by the user from the received information describing content or products accessed by the user, obtains characteristics of the determined products, and ranks products associated with the third party system or associated with other third party systems so products having greater amounts of characteristics matching characteristics of products previously accessed by the user have higher positions in the ranking. As another example, the online system extracts keywords, topics, or other information from content accessed by the user and ranks products associated with the third party system (or with other third party systems) based on characteristics of the products matching the extracted keywords, topics, or other information.

Based on the ranking, the online system identifies one or more candidate products of the products for which the online system received information from the third party system associated with the content item. For example, the online system identifies candidate products as products associated with a threshold position in the ranking and associated with the third party system. In some embodiments, the content item includes characteristics of products associated with the third party system from which the creative of the content item is determined. If the content item includes characteristics of products, the online system identifies products associated with the third party system that have at least the threshold position in the ranking and that have the characteristics included in the content item.

In some embodiments, the online system obtains information identifying sets of products associated with third party systems. For example, information received from a third party system includes different sets that each include one or more products. As an example, the online system receives information identifying a set of products that each have one or more common characteristics from a third party system. Allowing the third party system to specify related or similar products to the online system. The online system stores the set of products. If the online system identifies a product included in a set as a candidate product, the online system also identifies other products in the set as candidate products. For example, the online system identifies a product included in a set identified to the online system as a candidate product, so the online system also identifies other products included in the set as candidate products. In some embodiments, when the online system identifies a product in a set as a candidate product, the online system also identifies all other products in the set as candidate products. Alternatively, when the online system identifies a product in a set as a candidate product, the online system also identifies a subset of the products in the set as candidate products.

In various embodiments, if the online system does not identify at least one candidate product, the online system determines the content item is not eligible for presentation to the user and does not subsequently include the content item in one or more selection processes selecting content for presentation to the user. For example, if the online system includes characteristics of products from which the creative of the content item is generated, and at least one product associated with the third party system and having the included characteristics does not have at least a threshold position in the ranking, the online system determines the content item is not eligible for presentation to the user and withholds the content item from inclusion in one or more selection processes. Alternatively, if the online system determines that no products associated with the third party system have at least the threshold position in the ranking, the online system determines the content item is not eligible for presentation to the user and withholds the content item from inclusion in one or more selection processes. Hence, the online system may remove the content item from evaluation for presentation to the user if the ranking indicates the creative for the content item is unable to be generated from a product with which the user has at least a threshold likelihood of interaction.

From the candidate products, the online system generates one or more versions of the content item. Each version of the content item includes a creative describing a different candidate product. For example, the online system retrieves a subset of the information about different products previously received by the online system and generates different versions of the content item, each having creatives describing different candidate products, from the subset of the information.

The online system determines measures of relevance to the user for each of at least a subset of the versions of the content item. In some embodiments, the online system determines measures of relevance for each of the versions of the content item. A measure of relevance of a version of the content item provides a likelihood of the user interacting with the version of the content item. Hence, the determined measures of relevance allow the online system to evaluate likelihoods of the user interacting with different versions of the content item that include creatives describing different candidate products. To determine a measure of relevance for a version of the content item, the online system applies one or more models to characteristics of the user and to characteristics of the version of the content item. The one or more models are based on prior interactions by the user with previously presented content items. In some embodiments, the one or more models also account for prior interactions by other users, such as additional users having at least a threshold amount of characteristics matching characteristics of the user, with previously presented content items.

Based on the determined measures of relevance, the online system selects one or more versions of the content item. For example, the online system selects versions of the content item having at least a threshold measure of relevance to the user. In various embodiments, the threshold measure of relevance to the user is determined by the online system based on prior interactions by users with presented content items. Alternatively, the online system ranks the versions of the content item based on the determined measures of relevance and selects versions having at least a threshold position in the ranking. Additionally or alternatively, the online system may select a version of the content item having a creative describing a product previously accessed by the user.

Alternatively, the online system selects each version of the content item and associates a value of the measure of relevance of a version of the content item with the version of the content item with the version of the content item. In some embodiments, the online system associates the version of the content item's measure of relevance with the version of the content item. Alternatively, the online system converts the measures of relevance into values using any suitable conversion method and associates a corresponding value with the version of the content item. In these embodiments, the one or more selection processes account for the value associated with the version of the content item when selecting content for presentation to the user. For example, a likelihood of a version of the content item being selected for presentation to the user decreases if the measure of relevance of the candidate content item to the user is lower, while the likelihood of the version of the content item being selected for presentation to the user increases if the measure of relevance of the candidate content item to the user is higher.

To determine content for presentation to the user via the identified opportunity, the online system includes selected versions of the content item, which have creatives including information about one or more candidate products, in one or more selection processes selecting content for presentation to the user. A selection process may determine a likelihood of the user interacting with various content items, or determine a measure of relevance of various content items to the user, based on characteristics of the user and characteristics of the content item. Hence, including information about the candidate products in creatives of the selected versions of content item included in the one or more selection processes affects the likelihood of the user interacting with different versions of the content item. As the candidate products were selected based on content previously accessed by the user, having information about a candidate product in creatives of versions of the content item increases a likelihood of the user interacting with the versions of the content item, which affects evaluation of the content item by one or more selection processes. If the online system selects a version of the content item, the online system communicates selected version of content item having a creative including information about a particular candidate product to a client device associated with the user for presentation. In various embodiments, the selected version of the content item having the creative including information about the particular candidate product also includes a landing page specifying a network address for accessing the third party system or another source with additional information about the particular candidate product.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 flowchart of a method for generating a content item including information about a product selected by the online system for a user of the online system, in accordance with an embodiment.

FIG. 4 is a conceptual diagram of generation of a content item generated for a user by an online system based on products accessed by the user, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

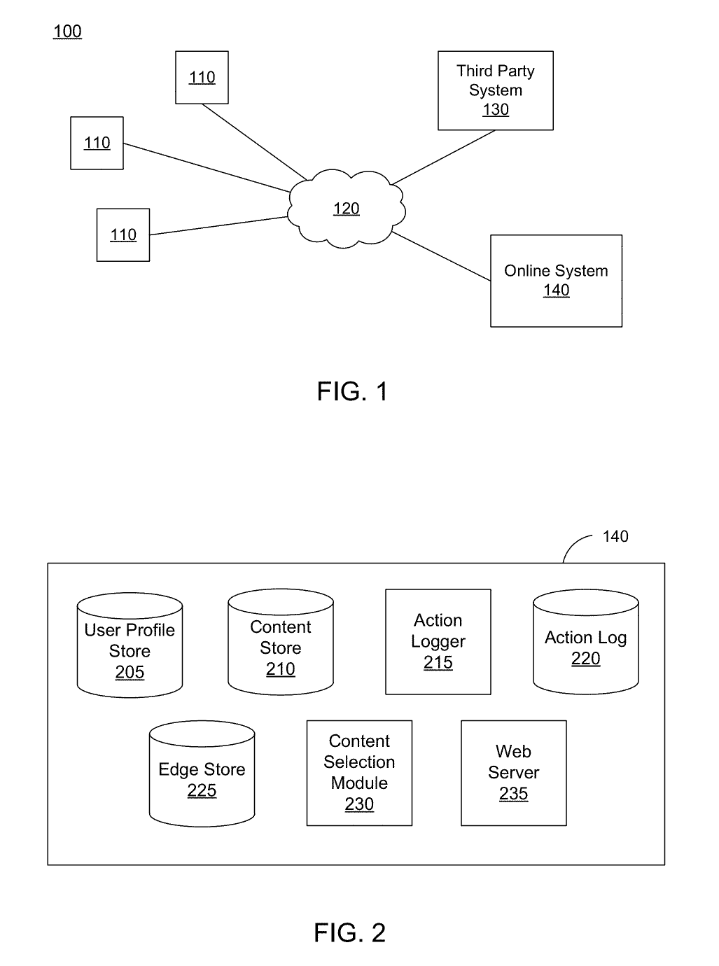

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. For example, the online system 140 is a social networking system, a content sharing network, or another system providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

Various third party systems 130 provide content to users of the online system 140. For example, a third party system 130 maintains pages of content that users of the online system 140 may access through one or more applications executing on a client device 110. The third party system 130 may provide content items to the online system 140 identifying content provided by the online system 140 to notify users of the online system 140 of the content provided by the third party system 130. For example, a content item provided by the third party system 130 to the online system 140 identifies a page of content provided by the online system 140 that specifies a network address for obtaining the page of content. If the online system 140 presents the content item to a user who subsequently accesses the content item via a client device 110, the client device 110 obtains the page of content from the network address specified in the content item. This allows the user to more easily access the page of content.

FIG. 2 is a block diagram of an architecture of the online system 140. The online system 140 shown in FIG. 2 includes a user profile store 205, a content store 210, an action logger 215, an action log 220, an edge store 225, a content selection module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image, with information identifying the images in which a user is tagged stored in the user profile of the user. A user profile in the user profile store 205 may also maintain references to actions by the corresponding user performed on content items in the content store 210 and stored in the action log 220.

Each user profile includes user identifying information allowing the online system 140 to uniquely identify users corresponding to different user profiles. For example, each user profile includes an electronic mail (“email”) address, allowing the online system 140 to identify different users based on their email addresses. However, a user profile may include any suitable user identifying information associated with users by the online system 140 that allows the online system 140 to identify different users.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third party applications or third party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

One or more content items included in the content store 210 include a creative, which is content for presentation to a user, and a bid amount. The creative is text, image, audio, video, or any other suitable data presented to a user. In various embodiments, the creative also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 140 if content in the content item is presented to a user, if the content in the content item receives a user interaction when presented, or if any suitable condition is satisfied when content in the content item is presented to a user. For example, the bid amount included in a content item specifies a monetary amount that the online system 140 receives from a user who provided the content item to the online system 140 if content in the content item is displayed. In some embodiments, the expected value to the online system 140 of presenting the content from the content item may be determined by multiplying the bid amount by a probability of the content of the content item being accessed by a user.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 140 logs interactions between users presented with the content item or with objects associated with the content item. Additionally, the online system 140 receives compensation from a user associated with content item as online system users perform interactions with a content item that satisfy the objective included in the content item.

Additionally, a content item may include one or more targeting criteria specified by the user who provided the content item to the online system 140. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements or other content with which the user engaged, purchases made, and other patterns from shopping and buying. Hence, the action log 220 may include information identifying content provided by one or more third party systems 130 that a user of the online system 140 has accessed or content provided by one or more third party systems 130 with which the user of the online system 140 otherwise interacted. Various third party systems 130 may include tracking mechanisms in content comprising instructions that, when executed by a client device 110, provide information identifying the content and identifying a user of the online system 140 associated with the client device 110 to the online system 140. In various embodiments, the information provided by the tracking mechanism identifies one or more products associated with a third party system 130 and include in, or otherwise associated with, the identified content. The information identifying the content is stored in the action log 220 in association with information identifying the user to the online system 140. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The content selection module 230 selects one or more content items for communication to a client device 110 to be presented to a user. Content items eligible for presentation to the user are retrieved from the content store 210 or from another source by the content selection module 230, which selects one or more of the content items for presentation to the viewing user. A content item eligible for presentation to the user is a content item associated with at least a threshold number of targeting criteria satisfied by characteristics of the user or is a content item that is not associated with targeting criteria. In various embodiments, the content selection module 230 includes content items eligible for presentation to the user in one or more selection processes, which identify a set of content items for presentation to the user. For example, the content selection module 230 determines measures of relevance of various content items to the user based on characteristics associated with the user by the online system 140 and based on the user's affinity for different content items. Based on the measures of relevance, the content selection module 230 selects content items for presentation to the user. As an additional example, the content selection module 230 selects content items having the highest measures of relevance or having at least a threshold measure of relevance for presentation to the user. Alternatively, the content selection module 230 ranks content items based on their associated measures of relevance and selects content items having the highest positions in the ranking or having at least a threshold position in the ranking for presentation to the user.

Content items eligible for presentation to the user may include content items associated with bid amounts. The content selection module 230 uses the bid amounts associated with ad requests when selecting content for presentation to the user. In various embodiments, the content selection module 230 determines an expected value associated with various content items based on their bid amounts and selects content items associated with a maximum expected value or associated with at least a threshold expected value for presentation. An expected value associated with a content item represents an expected amount of compensation to the online system 140 for presenting the content item. For example, the expected value associated with a content item is a product of the ad request's bid amount and a likelihood of the user interacting with the content item. The content selection module 230 may rank content items based on their associated bid amounts and select content items having at least a threshold position in the ranking for presentation to the user. In some embodiments, the content selection module 230 ranks both content items not associated with bid amounts and content items associated with bid amounts in a unified ranking based on bid amounts and measures of relevance associated with content items. Based on the unified ranking, the content selection module 230 selects content for presentation to the user. Selecting content items associated with bid amounts and content items not associated with bid amounts through a unified ranking is further described in U.S. patent application Ser. No. 13/545,266, filed on Jul. 10, 2012, which is hereby incorporated by reference in its entirety.

For example, the content selection module 230 receives a request to present a feed of content to a user of the online system 140. The feed may include one or more content items associated with bid amounts and other content items that are not associated with bid amounts, such as stories describing actions associated with other online system users connected to the user. The content selection module 230 accesses one or more of the user profile store 205, the content store 210, the action log 220, and the edge store 225 to retrieve information about the user. For example, information describing actions associated with other users connected to the user or other data associated with users connected to the user are retrieved. Content items from the content store 210 are retrieved and analyzed by the content selection module 230 to identify candidate content items eligible for presentation to the user. For example, content items associated with users who not connected to the user or stories associated with users for whom the user has less than a threshold affinity are discarded as candidate content items. Based on various criteria, the content selection module 230 selects one or more of the content items identified as candidate content items for presentation to the identified user. The selected content items are included in a feed of content that is presented to the user. For example, the feed of content includes at least a threshold number of content items describing actions associated with users connected to the user via the online system 140.

In various embodiments, the content selection module 230 presents content to a user through a newsfeed including a plurality of content items selected for presentation to the user. One or more content items may also be included in the feed. The content selection module 230 may also determine the order in which selected content items are presented via the feed. For example, the content selection module 230 orders content items in the feed based on likelihoods of the user interacting with various content items.

In various embodiments, the content selection module 230 also maintains information describing various products and selects a product for a user of the online system 140. For example, various third party systems 130 provide information to the content selection module 230 specifying characteristics of various products associated with the third party systems 130. As an example, a third party system 130 provides information to the content selection module 230 including identifiers of products sold or maintained by the third party system 130; associated with each identifier are one or more characteristics of a product corresponding to an identifier (e.g., a description of the product, keywords associated with the product, a name of the product, dimensions of the product, reviews of the product, etc.).

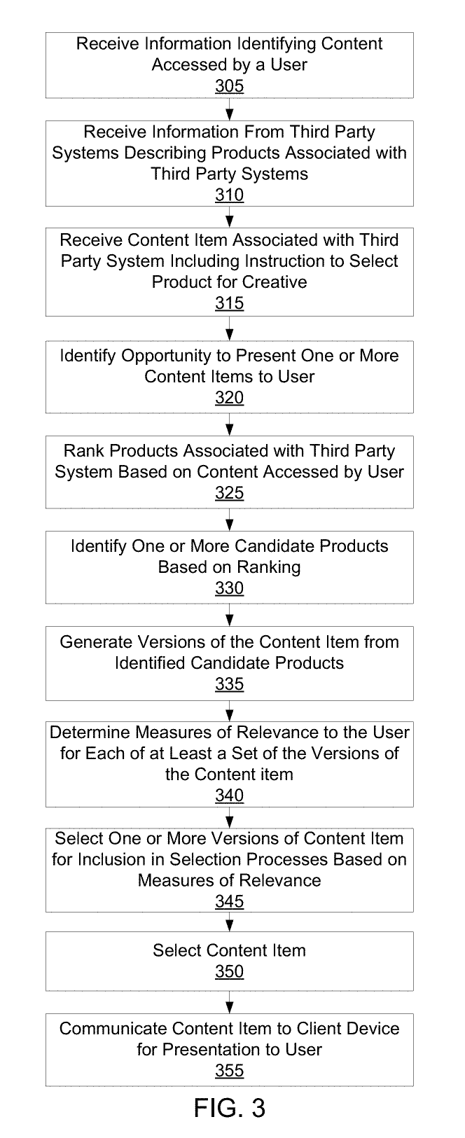

Based on information included in the action log 220 identifying content accessed by a user, the content selection module 230 selects candidate products from the maintained information for the user. In some embodiments, the content selection module 230 determines likelihoods of the user interacting with content including information based products associated with various third party systems 130 based on characteristics of the products and characteristics of products with which the user previously accessed and ranks the products based on the determined likelihoods. The content selection module 230 selects candidate products based on the ranking, as further described below in conjunction with FIG. 3. In some embodiments, the content selection module 230 selects candidate products as products having at least a threshold position in the ranking. As another example, the content item includes one or more characteristics of a product, and the content selection module 230 selects candidate products as products associated with the third party system, having the one or more characteristics, and having at least the threshold position in the ranking. In some embodiments, if the content selection module 230 cannot identify at least one candidate product from the ranking, the content selection module 230 withholds the content item from inclusion in one or more selection processes. For example, if no content item associated with the third party system 130 having at least a threshold position in the ranking has characteristics included in the content item, the content selection module 230 is unable to select candidate products for the content item from the ranking; accordingly, the content selection module 230 withholds the content item from inclusion in one or more selection processes.

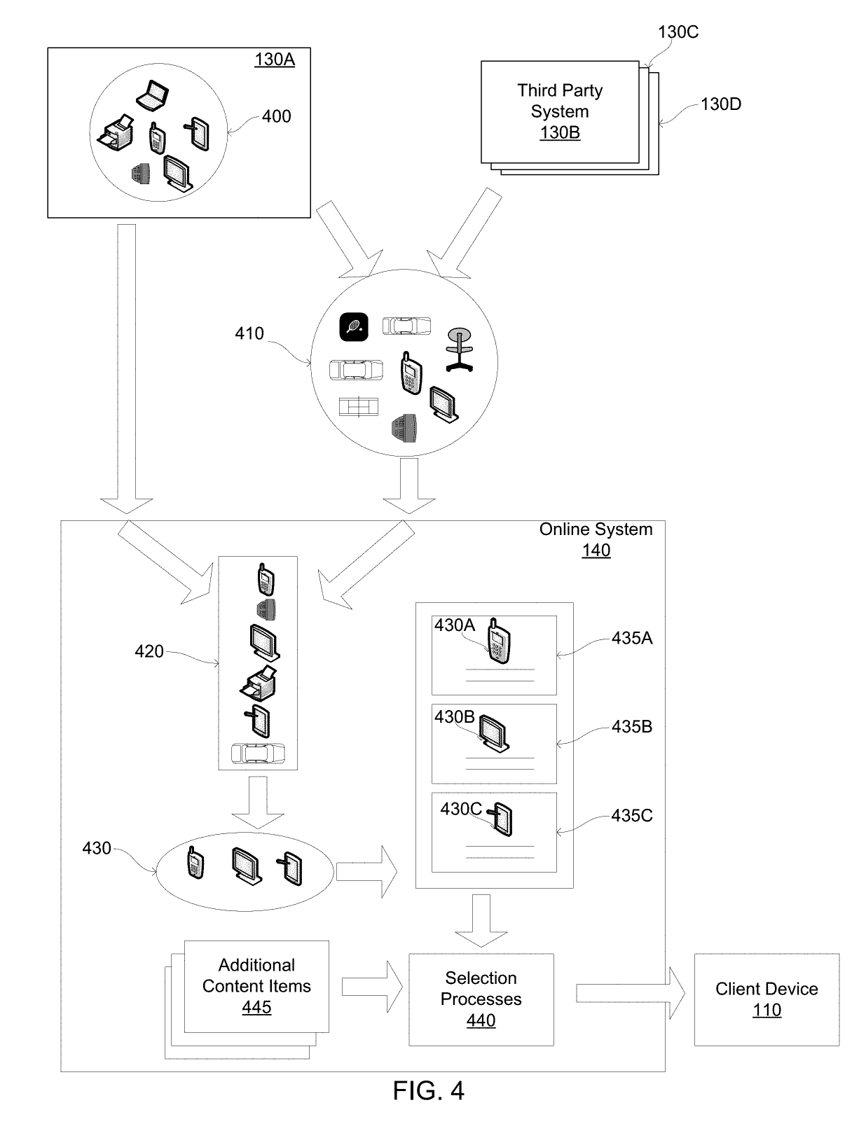

For each of at least a set of the selected candidate products, the content selection module 230 generates a version of the content item having a creative describing a selected candidate product. For example, the content selection module generates versions of the content item for each of the candidate products. As an example, each version of the content item includes an image and a name of a different candidate product in its corresponding creative. However, in other embodiments, versions of the content item include any suitable information describing a candidate product. The content selection module 230 applies one or more models to the versions of the content item to generate measures of relevance to the user of each version of the content item, as further described below in conjunction with FIG. 3. Based on the measures of relevance, the content selection module 230 selects versions of the content item to include in one or more selection processes along with other content items. In some embodiments, the content selection module 230 selects versions of the content item having at least a threshold measure of relevance to the user. Alternatively, the content selection module 230 ranks versions of the content item based on their measures of relevance and selects versions of the content item having at least a threshold position in the ranking. In other embodiments, the content selection module 230 associates a value with each version of the content item based on a corresponding measure of relevance for each version of the content item and includes each version of the content item along with its associated value in the one or more selection processes; hence, the one or more selection processes may account for the values associated with different versions of the content item when selecting content for presentation to the user. As further described above, the one or more selection processes select content form the content item having the content describing the selected product and other content items and communicate the selected content to a client device 110 associated with the user for presentation. Selection of a product and inclusion of content describing the product in a content item is further described below in conjunction with FIGS. 3 and 4.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, or BlackberryOS.

### Generating a Content Item for a User Including Content Describing a Product Selected by an Online System for the User

FIG. 3 is a flowchart of one embodiment of a method for generating a content item including content provided by an application associated with a third party system 140 identifying a product selected by the online system 140 for presentation to a user of the online system 140. In other embodiments, the method may include different and/or additional steps than those shown in FIG. 3. Additionally, steps of the method may be performed in different orders than the order described in conjunction with FIG. 3 in various embodiments.

As a user of the online system 140 accesses content provided by one or more third party systems 130, the online system 140 receives 305 information identifying the content accessed by the user. In various embodiments, content provided by different third party systems 130 includes information describing products provided by or otherwise associated with one or more third party systems 130, and the online system 140 receives 305 information identifying products associated with a third party system 130 accessed by the user. For example, a third party system 130 includes a tracking mechanism in content presented to users. The tracking mechanism comprises instructions that, when executed by a client device 110 presenting the content, obtain information identifying one or more products included in the content and information identifying the user to the online system 140 and communicate the information identifying the one or more products and identifying the user to the online system 140. In various embodiments, the tracking mechanism may communicate additional information to the online system 140 describing interaction with the content by the user of the online system 140. For example, the tracking mechanism communicates information describing one or more interactions by the user with various portions of the presented content corresponding to an identified product to the online system 140. The online system 140 stores received information identifying products associated with one or more third party systems 130 accessed by the user or identifying content associated with a one or more third party systems 130 accessed by the user in association with the user.

Additionally, the online system 140 receives information describing interactions with content provided by the online system 140 that is associated with one or more products associated with the third party system 130. For example, the online system 140 presents content items describing or identifying various products associated with the third party system 130. As the online system 140 receives interactions with the presented content items, the online system 140 stores information describing an interaction by the user with a content item associated with a product in association with the user, with the content item, and with the product. In various embodiments, the third party system 130 identifies products associated with various content items presented by the online system 140. Alternatively, the online system 140 analyzes characteristics of a content item, determines one or more products associated with the content item from the characteristics of the content item, and stores identifiers of the determined products in association with the content item.

Various third party systems 130 provide the online system 140 with information describing products associated with the third party systems 130, such as products offered for sale or otherwise provided by the one or more third party systems 130. Products associated with the third party system 130 may be any good or service. Example products include: travel offers (e.g., hotel reservations, flight reservations, real estate listings, media (e.g., video, audio) offered for sale or for use, physical goods, services provided by the third party system, or any other item associated with the third party system. For example, a third party system 130 provides the online system 140 with a catalog including product identifiers used by the third party system 130 for various products. The catalog also includes characteristics associated with different products by the third party system 130. For example, the catalog includes a product identifier associated with a product by the third party system 130 as well as a title, a description, one or more keywords, and any other suitable information associated with the product identifier. Different third party systems 130 may provide the online system 140 with different characteristics associated with products. Hence, the online system 140 receives 310 information from one or more third party systems 130 describing products associated with the third party systems 130. In some embodiments, the online system 140 locally maintains information provided by a third party system 130 describing products associated with the third party system. For example, the online system 140 stores information describing products in association with an identifier of a third party system 130 that provided the information to the online system 140. Alternatively, the online system 140 retrieves information describing products from a third party system 130 associated with the products or providing the products.

The online system 140 also receives 315 a content item associated with a third party system 130 for presentation to one or more users of the online system 140 that includes a creative presenting content describing a product associated with a third party system 130. To increase a likelihood of users interacting with the content item when it is presented, the content item includes instructions that cause the online system 140 to select the product included in the creative and to generate the creative for the content item based on the selected product. Hence, rather than identify a specific product that is presented to each user to whom the content item is presented, the instructions included in the content item allow the online system 140 to dynamically identify the product presented by the creative for different users. This allows the online system 140 to present different content to different users via the content item, which increases a likelihood of the user interacting with the content item. The online system 140 may receive 315 the content item from the third party system 130 or may receive 315 the content item from another third party system 130 or from another entity.

When the online system 140 identifies 320 an opportunity to present one or more content items to the user, the online system 140 ranks 325 products associated with the third party system 130 based on characteristics of the products associated with the third party system 130 and characteristics of products previously accessed by the user. In various embodiments, based on characteristics of the products associated with the third party system 130, characteristics of products previously accessed by the user, and interactions by the user with content associated with products accessed by the user, the online system 140 determines likelihoods of the user interacting with content including information describing different products associated with the third party system 130. Based on the likelihoods of interaction, the online system 140 ranks 325 products associated with the third party system 130.

In some embodiments, the online system 140 ranks 325 products associated with the third party system 130 along with products associated with other third party systems 130, generating a ranking that includes products associated with different third party systems 130. For example, the online system 140 ranks 325 products associated with all third party systems 130 that provided the online system 140 with information describing products, generating a unified product ranking that includes products associated with multiple third party systems 130. Hence, the unified product ranking organizes products that multiple third party systems 130 have identified to the online system 140 ranked based on likelihoods of the user interacting with content describing various products. To rank 325 the products, the online system 140 may apply one or more models to characteristics of products associated with the third party system 130 (or associated with other third party systems 130), to characteristics of the user, and to characteristics of products previously accessed by the user to determine likelihoods of the user interacting with content that describes different products. For example, the online system 140 compares characteristics of products associated with one or more third party systems 130 accessed by the user to characteristics of products associated with the third party system 130 and ranks 325 products based on amounts (e.g., a number, a percentage) of characteristics of products matching characteristics of products previously accessed by the user. For example, the online system 140 determines products included in content accessed by the user from the received information describing content or products accessed by the user, obtains characteristics of the determined products, and ranks 325 products associated with the third party system 130 or associated with other third party systems 130 so products having greater amounts of characteristics matching characteristics of products previously accessed by the user have higher positions in the ranking. As another example, the online system 140 extracts keywords, topics, or other information from content accessed by the user and ranks 325 products associated with the third party system 130 (or with other third party systems 130) based on characteristics of the products matching the extracted keywords, topics, or other information.

In some embodiments, the online system 140 includes products associated with the third party system 130 (or with other third party systems 130) that were previously accessed by the user in the ranking. Alternatively, the online system 140 ranks 325 products associated with the third party system (or with other third party systems 130) with which the user had not previously interacted based on amounts or characteristics that match characteristics of products with which the user previously interacted. In some embodiments, the online system 140 ranks 325 products associated with the third party system 130 (or associated with other third party systems 130) based on characteristics of the products associated with the third party system 130 (or associated with other third party systems 130) matching characteristics of content items the user accessed within a threshold amount of time from a time when the opportunity to present one or more content items to the user was identified 320. As another example, the online system 140 ranks 325 products associated with the third party system 130 (or associated with other third party systems 130) based on characteristics of the products associated with the third party system 130 (or associated with other third party systems 130) matching characteristics of products that the user accessed at least a threshold number of times within a particular time interval.

In various embodiments, the online system 140 accounts for products accessed by additional users when ranking 325 products associated with the third party system 130 (or associated with other third party systems 130). The online system 140 may account for products accessed by additional users, or characteristics of the additional users, if the online system 140 determines the user accessed less than a threshold number of products within a particular time interval. For example, the online system 140 determines likelihoods of the user interacting with content describing various products associated with the third party system 130 (or associated with other third party systems 130) based on products previously accessed by the additional users. In various embodiments, the online system 140 maintains one or more models determining likelihoods of users interacting with content describing different products based on products previously accessed by additional users and characteristics of users. The online system 140 applies the one or more models to characteristics of products associated with the third party system 130 (or associated with other third party systems 130) and characteristics of the user and ranks 325 the products associated with the third party system 130 (or associated with other third party systems 130) based on the likelihoods determined from application of the model. In various embodiments, the one or more models may account for lengths of time between a current time and times when the user or when additional users accessed various products. For example, one or more models apply decay factors to characteristics of products or characteristics of users that attenuate the characteristics of the products of the users as a length of time between the current time and the times when the users accessed products increases.

In other embodiments, the online system 140 ranks products associated with the third party system 130 (or associated with other third party systems 130) based on a number of other online system users who accessed the products or a number of times online system users accessed the products within a specific time interval. Alternatively or additionally, the online system 140 accounts for products accessed by a particular set of additional users when ranking 325. For example, the online system 140 identifies additional users having at least a threshold amount of characteristics matching characteristics of the user and determines likelihoods of the user interacting with content describing various products based on characteristics of products previously accessed by the user and by the identified additional users. Based on the determined likelihoods, the online system 140 ranks 325 products associated with the third party system 130 (or associated with other third party systems 130).

In some embodiments, the online system 140 ranks 325 the candidate products by characterizing products associated with the third party system 130 and products associated with other third party systems as vectors of factors and similarly characterizes the user and other users as vectors of factors based on characteristics of the user or of the other users. The online system 140 may generate a matrix having a dimension representing users who accessed or otherwise interacted with products and another dimension representing products associated with the third party system 130 or with another third party system 130. Hence, the online system 140 maintains a vector for each of at least a set of users and each of at least a set of products associated with the third party system 130 or associated with other third party systems 130. For a product associated with the third party system 130, the vector associated with the product includes elements providing a measure of an extent to which the product has a characteristic corresponding to an element. Similarly, the vector associated with the user has different elements having values representing a likely interest of the user in a product having a characteristic that are determined from prior interactions by the user as well as additional users. Hence, a dot product of the vector for a product and the vector for the user provides a measure of the user's interest in the product. The online system 140 ranks 325 the products associated with the third party system 130 (or with other third party systems 130) by the determined measures of the user's interest in some embodiments. The online system 140 may use any suitable matrix factorization method to determine the measures of the user's interest in different products.

Based on the ranking, the online system 140 identifies 330 one or more candidate products of the products for which the online system 140 received information from the third party system 130 associated with the content item. For example, the online system 140 identifies 330 candidate products as products associated with a threshold position in the ranking and associated with the third party system 130. In some embodiments, the content item includes characteristics of products associated with the third party system 140 from which the creative of the content item is determined. If the content item includes characteristics of products, the online system 140 identifies 330 products associated with the third party system 130 that have at least the threshold position in the ranking and that have the characteristics included in the content item.

In some embodiments, the online system 140 obtains information identifying sets of products associated with third party systems 130. For example, information received 310 from a third party system 130 includes different sets that each include one or more products. As an example, the online system 140 receives 310 information identifying a set of products that each have one or more common characteristics from a third party system 130, allowing the third party system 130 to specify related or similar products to the online system 140. The online system 140 stores the set of products. If the online system 140 identifies 330 a product included in a set as a candidate product, the online system 140 also identifies 330 other products in the set as candidate products. For example, the online system 140 identifies 330 a product included in a set identified to the online system 140 as a candidate product, so the online system 140 also identifies 330 other products included in the set as candidate products. In some embodiments, when the online system 140 identifies 330 a product in a set as a candidate product, the online system 140 also identifies 330 all other products in the set as candidate products. Alternatively, when the online system 140 identifies 330 a product in a set as a candidate product, the online system 140 also identifies 330 a subset of the products in the set as candidate products.

In various embodiments, if the online system 140 does not identify 330 at least one candidate product, the online system 140 determines the content item is not eligible for presentation to the user and does not subsequently include the content item in one or more selection processes selecting content for presentation to the user. For example, if the online system 140 includes characteristics of products from which the creative of the content item is generated, and at least one product associated with the third party system 130 and having the included characteristics does not have at least a threshold position in the ranking, the online system 140 determines the content item is not eligible for presentation to the user and withholds the content item from inclusion in one or more selection processes. Alternatively, if the online system 140 determines that no products associated with the third party system 130 have at least the threshold position in the ranking, the online system 140 determines the content item is not eligible for presentation to the user and withholds the content item from inclusion in one or more selection processes. Hence, the online system 140 may remove the content item from evaluation for presentation to the user if the ranking indicates the creative for the content item is unable to be generated from a product with which the user has at least a threshold likelihood of interaction.

From the candidate products, the online system 140 generates 335 one or more versions of the content item. Each version of the content item includes a creative describing a different candidate product. For example, the online system 140 requests information describing various candidate products from the third party system 130 and generates versions of the content item including creatives describing different candidate products based on the requested information. As another example, the online system 140 retrieves a subset of the information about different products previously received 310 by the online system 140 and generates 335 different versions of the content item, each having creatives describing different candidate products, from the subset of the information.

The online system 140 determines 340 measures of relevance to the user for each of at least a subset of the versions of the content item. In some embodiments, the online system 140 determines 340 measures of relevance for each of the versions of the content item. A measure of relevance of a version of the content item provides a likelihood of the user interacting with the version of the content item. Hence, the determined measures of relevance allow the online system 140 to evaluate likelihoods of the user interacting with different versions of the content item that include creatives describing different candidate products. To determine a likelihood of the user interacting with version of the content item, the online system 140 applies one or more models to characteristics of the user and to characteristics of the version of the content item. The one or more models are based on prior interactions by the user with previously presented content items. In some embodiments, the one or more models also account for prior interactions by other users, such as additional users having at least a threshold amount of characteristics matching characteristics of the user, with previously presented content items.

Based on the determined measures of relevance, the online system 140 selects 345 one or more versions of the content item. For example, the online system 140 selects 345 versions of the content item having at least a threshold measure of relevance to the user. In various embodiments, the threshold measure of relevance to the user is determined by the online system 140 based on prior interactions by users with presented content items. Alternatively, the online system 140 ranks the versions of the content item based on the determined measures of relevance and selects 345 versions having at least a threshold position in the ranking. Additionally or alternatively, the online system 140 may select 345 a version of the content item having a creative describing a product previously accessed by the user.

Alternatively, the online system 140 selects 345 each version of the content item and associates a value of the measure of relevance of a version of the content item with the version of the content item with the version of the content item. In some embodiments, the online system 140 associates the version of the content item's measure of relevance with the version of the content item. Alternatively, the online system 140 converts the measures of relevance into values using any suitable conversion method and associates a corresponding value with the version of the content item. In these embodiments, the one or more selection processes, further described above in conjunction with FIG. 2, account for the value associated with the version of the content item when selecting content for presentation to the user. For example, a likelihood of a version of the content item being selected for presentation to the user decreases if the measure of relevance of the candidate content item to the user is lower, while the likelihood of the version of the content item being selected for presentation to the user increases if the measure of relevance of the candidate content item to the user is higher. Hence, the measure of relevance of a version of the content item is included in criteria evaluated by the one or more selection processes when selecting content for presentation to the user, and may affect content selected for presentation to the user by the online system 140.

To select content for presentation to the user, the online system 140 includes the selected versions of the content item along with additional content items in one or more selection processes selecting content for presentation to the user. Hence, in some embodiments, the online system 140 includes versions of the content item having at least a threshold measure of relevance to the user or having at least a threshold position in a ranking based on measures of relevance to the user in the one or more selection processes. Examples of selection processes used by the online system 140 to select content for presentation to the user are further described above in conjunction with FIG. 2. For example, a selection process determines a likelihood of the user interacting with various content items, or a measure of relevance of various content items to the user, based on characteristics of the user and characteristics of the content items. Hence, including the selected versions of the content item in the one or more selection processes allows the online system 140 to account for inclusion of content describing various candidate products included in creatives of different versions of the content item likelihoods of the user interacting with affecting likelihoods of the user interacting with different versions of the content item or measures of relevance of different versions of the content item to the user, which affects whether one or more of the selection processes select a version of the content item for the user. As the online system 140 ranks 325 the products based on content previously accessed by the user and selects 345 versions of the content item based on likelihoods of the user interacting with various versions of the content item including information about different products, the versions of the content item included in the one or more selection processes include creatives that increase likelihoods of the user interacting with the content item, affecting evaluation of the versions of the content item by the one or more selection processes.

If the online system 140 selects 350 a version of the content item, the online system 140 communicates 355 the selected version of the content item including a creative having content describing a particular candidate product to a client device 110 associated with the user for presentation. For example, if the version of the content item having a creative including content describing a candidate product has at least a threshold measure of relevance or a hast least a threshold likelihood of obtaining an interaction by the user, the online system 140 selects 350 and communicates 355 the selected version of the content item having the creative including content describing the candidate product to a client device 110 for presentation to the user. As another example, if a version of the content item having a creative including content describing a candidate product is associated with a bid amount, one or more selection processes determine expected values to the online system 140 of presenting various content items based on bid amounts included in the content items and likelihoods of the user interacting with the content items. The one or more selection processes rank the content items by their expected values, and the online system 140 selects 350 the version of the content item having the creative including content describing the candidate product if the version of the content item has at least a threshold position in the ranking. As referenced above, the candidate product included in the selected version of the content item may be any good or service associated with the third party system 130. Examples of candidate products include: travel offers (e.g., hotel reservations, flight reservations, real estate listings, media (e.g., video, audio) offered for sale or for use, physical goods, services provided by the third party system, or any other item associated with the third party system 130.

In various embodiments, various versions of the content item having creatives including content describing candidate products also include a landing page specifying a network address for obtaining additional information about the candidate product described by a creative of the version of the content item. For example, the landing page specifies a network address of a web page maintained by the third party system 130 for purchasing the candidate product via the third party system 130. If the user selects or otherwise accesses the version content item having the creative including content describing a candidate product and including a landing page, the client device 110 retrieves the additional information about the candidate product from the network address included in the version of the content item.

FIG. 4 is a conceptual diagram of an online system 140 generating a content item for a user of the online system 140 based on products accessed by users of the online system 140. As described above in conjunction with FIG. 3, the online system 140 obtains information 400 about products associated with a third party system 130A. For example, the third party system 130A provides the online system 140 with information 400 including identifiers of various products associated with the third party system 130A, characteristics of various products associated with the third party system 130A (e.g., descriptions of products, keywords associated with products, pricing information for products, or any other suitable information). The online system 140 may periodically request the information 400 about the products from the third party system 130A. Additionally or alternatively, the third party system 130A may provide the information 400 describing products associated with the third party system 130A to the online system 140 without receiving a request from the online system 140. For example, the third party system 130A provides information 400 describing a product that is newly associated with the third party system (e.g., a product newly offered for sale by the third party system 130A). As another example, the third party system 130A periodically communicates information 400 describing products associated with the third party system 130A to the online system 140.

The online system 140 also receives information describing products 410 associated with various third party systems 130A, 130B, 130C, 130D accessed by users of the online system 140, as further described above in conjunction with FIG. 3. In some embodiments, the online system 140 receives information from various third party systems 130B, 130C, 130D describing products 410 associated with the various third party systems 130A, 130B, 130C, 130D accessed by a user of the online system 140. The online system 140 may also receive information from various third party systems 130A, 130B, 130C, 130D identifying products associated with the various third party systems 130A, 130B, 130C, 130D accessed by additional users of the online system 140. While FIG. 4 shows an example where the online system 140 receives information describing products 410 associated with third party systems 130A, 130B, 130C, 130D accessed by the user, in other embodiments, the online system 140 receives information identifying content associated with various third party systems 130A, 130B, 130C, 130D accessed by the user and identifies products 410 associated with the third party systems 130A, 130B, 130C, 130D that the user accessed from the content accessed by the user. For example, various third party systems 130A, 130B, 130C, 130D include tracking mechanisms in content provided by the third party system 130A, 130B, 130C, 130D. A tracking mechanism comprises instructions that, when executed by a client device 110 presenting the content, communicate information to the online system 140 identifying one or more products 410 included in the accessed content or identifying one or more products 410 accessed by a user of the client device 110 via the presented content. Different third party systems 130A, 130B, 130C, 130D include tracking mechanisms in various content provided by the third party systems 130A, 130B, 130C, 130D to provide information to the online system 140 identifying content from the various third party systems 130A, 130B, 130C, 130D presented to the user. The online system 140 stores information identifying products 410 associated with a third party system 130A, 130B, 130C, 130D accessed by a user in association with the user and in association with the third party system 130A, 130B, 130C, 130D associated with the products 410 to maintain a log of products 410 associated with one or more third party systems 130A, 130B, 130C, 130D that the user has accessed. In other embodiments, the online system 140 may receive the information describing products 410 accessed by the user from third party systems 130A, 130B, 130C, 130D themselves or from any suitable source.

As further described above in conjunction with FIG. 3, the online system 140 receives a content item associated with a third party system 130A and including instructions for generating a creative of the content item that describes a product 410 associated with the third party system 130A that is selected by the online system 140. When the online system 140 identifies an opportunity to present content to a user and the content item is eligible for presentation to the user, as further described above in conjunction with FIG. 3, the online system 140 ranks products associated with the third party system 130A. In various embodiments, the online system 140 ranks products associated with the third party system 130A and products associated with other third party systems 130B, 130C, 130D. In the example of FIG. 4, the online system 140 generates a ranking 420 including products associated with the third party system 130A and associated with other third party systems 130B, 130C, 130D. As further described above in conjunction with FIG. 3, the online system 140 generates the ranking 420 based on characteristics of the products 400 associated with the third party system 130A, characteristics of products associated with other third party systems 130B, 130C, 130D, and characteristics of products 410 previously accessed by the user. In various embodiments, based on characteristics of the products 400 associated with third party system 130A, products associated with other third party systems 130B, 130C, 130D, and characteristics of products 410 previously accessed by the user, the online system 140 determines likelihoods of the user interacting with content including information describing different products 400 associated with the third party system 130A and products associated with other third party systems 130B, 130C, 130D. Based on the likelihoods of interaction, the online system 140 generates the ranking 420.

Based on the ranking 420, the online system 140 identifies one or more candidate products 430 of the products 400 associated with the third party system 130A. For example, the content item includes characteristics of products and the online system 140 identifies products associated with the third party system 130A that have at least the threshold position in the ranking 420 and that have the characteristics included in the content item as candidate products 430. Identification of candidate products 430 from the ranking 420 is further described above in conjunction with FIG. 3.

From the candidate products 430, the online system 140 generates one or more versions 435A, 435B, 435C of the content item. Each version 435A, 435B, 435C of the content item includes a creative describing a different candidate product 430A, 430B, 430C. In the example of FIG. 4A, version 435A of the content item includes a creative describing candidate product 430A, while version 435B of the content item includes a creative describing candidate product 430B. Similarly, version 430C of the content item includes a creative describing candidate product 430C.

As further described above in conjunction with FIG.3, the online system 140 determines measures of relevance to the user for each of at least a subset of the versions 435A, 435B, 435C of the content item. In some embodiments, the online system 140 determines measures of relevance for each of the versions 435A, 435B, 435C of the content item. A measure of relevance of a version 435A, 435B 435C of the content item provides a likelihood of the user interacting with the version of the content item, so the determined measures of relevance allow the online system 140 to evaluate likelihoods of the user interacting with versions 435A, 435B, 435C of the content item including creatives describing different candidate products 430A, 430B, 430C.

Based on the determined measures of relevance, the online system 140 selects one or more versions 435A, 435B, 435C of the content item. For example, the online system 140 selects versions 435A, 435B, 435C of the content item having at least a threshold measure of relevance to the user. As another example, the online system 140 ranks the versions 435A, 435B, 435C of the content item based on the determined measures of relevance and selects versions 435A, 435B, 435C of the content item having at least a threshold position in the ranking.

As further described above in conjunction with FIGS. 2 and 3, the online system 140 includes the selected versions 435A, 435B, 435C of the content item in one or more selection processes 440 selecting content for presentation to the user. The selection processes 440 evaluate likelihoods of the user interacting with the various selected versions 435A, 435B, 435C of the content item having creatives describing different candidate products 430A, 430B, 430C and likelihoods of the user interacting with additional content items 445. In various embodiments, the online system 140 applies one or more models to characteristics of the versions 435A, 435B, 435C of the content item and to characteristics of the additional content items 445 to determine likelihoods of the user interacting with the versions 435A, 435B, 435C of the content item and interacting with the additional content items 445. As further described above in conjunction with FIGS. 2 and 3, the online system 140 uses the determined likelihoods to select content items from the versions 435A, 435B, 435C of the content item and the additional content items 445. Hence, the online system 140 accounts for different likelihoods of the user interacting with versions 435A, 435B, 435C of the content item having creatives describing different candidate products 430A, 430B, 430C when including content in the one or more selection processes 440 when selecting content for presentation to the user; hence, versions 435A, 435B, 435C of the content item included in the one or more selection processes 440 are versions 435A, 435B, 435C with which the user is most likely to interact. Subsequently, the online system 140 evaluates likelihoods of the user interacting with various versions 435A, 435B, 435C of the content item and interacting with additional content items 445 to select content for communication to a client device 110 for presentation to the user. Hence, the content communicated from the online system 140 to the client device 110 is more likely to be content with which the user interacts.

### Conclusion

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
obtaining, at an online system, information from a third party system describing characteristics of one or more products associated with the third party system;
receiving information identifying products accessed by a user of an online system;
receiving a content item at the online system for presentation to one or more users of the online system, the content item including a creative presenting content describing a product of the one or more products associated with the third party system;
identifying an opportunity to present one or more content items to the user of the online system;
ranking the products associated with the third party system based on the received information identifying products accessed by the user of the online system and characteristics of the products associated with the third party system;
identifying one or more candidate products of the products associated with the third party system for presentation to the user of the online system based on the ranking;
generating one or more versions of the content item from the one or more candidate products of the products associated with the third party system and the content item, each version of the content item having the creative including content describing a candidate product;
determining measures of relevance of each of the one or more versions of the content item to the user;
selecting one or more versions of the candidate content items based on the determined measures of relevance;
including the selected one or more versions of the content item in one or more selection processes selecting content for presentation to the user via the identified opportunity;
selecting a version of the content item including the creative including content describing one of the candidate products via the identified opportunity; and
communicating the selected version of the content item to a client device for presentation to the user.

2. The method of claim 1, wherein ranking the products associated with the third party system based on the received information identifying products accessed by the user of the online system and characteristics of the products associated with the third party system comprises:
determining likelihoods of the user interacting with at least a set of the products associated with the third party system based on the received information identifying products accessed by the user of the online system and characteristics of the products associated with the third party system; and
ranking the products associated with the third party system based on the determined likelihoods.

3. The method of claim 1, wherein ranking the products associated with the third party system based on the received information identifying products accessed by the user of the online system and characteristics of the products associated with the third party system comprises:
ranking the products associated with the third party system and products associated with other third party systems based on received information identifying products accessed by the user of the online system, characteristics of the products associated with the third party system comprises, and characteristics of the products associated with other third party systems.

4. The method of claim 3, wherein ranking the products associated with the third party system and products associated with other third party systems based on received information identifying products accessed by the user of the online system, characteristics of the products associated with the third party system comprises, and characteristics of the products associated with other third party systems comprises:
determining likelihoods of the user interacting with each of the products associated with the third party system based on the received information identifying products accessed by the user of the online system and characteristics of the products associated with the third party system;
determining additional likelihoods of the user interacting with each of the products associated with the other third party systems based on the received information identifying products accessed by the user of the online system and characteristics of the products associated with the other third party systems; and
ranking the products associated with the third party system and the products associated with the other third party systems based on the likelihoods and the additional likelihoods.

5. The method of claim 1, wherein selecting one or more versions of the candidate content items based on the determined measures of relevance comprises:
ranking the one or more versions of the content item based on the determined measures of relevance; and
selecting versions of the content item having at least a threshold position in the ranking of the one or more versions of the content item.

6. The method of claim 1, wherein selecting one or more versions of the candidate content items based on the determined measures of relevance comprises:
selecting versions of the content item having at least a threshold measure of relevance.

7. The method of claim 1, wherein the content item includes one or more characteristics of products to be described by the creative.

8. The method of claim 7, wherein identifying one or more candidate products of the products associated with the third party system for presentation to the user of the online system based on the ranking comprises:
identifying products associated with the third party system having the one or more characteristics included in the content item and having at least a threshold position in the ranking.

9. The method of claim 1, wherein identifying one or more candidate products of the products associated with the third party system for presentation to the user of the online system based on the ranking comprises:
identifying one or more products associated with the third party system having at least a threshold position in the ranking.

10. The method of claim 1, wherein obtaining, at the online system, information from the third party system describing characteristics of one or more products associated with the third party system comprises:
obtaining information from the third party system identifying a set of products associated with the third party system.

11. The method of claim 10, wherein identifying one or more candidate products of the products associated with the third party system for presentation to the user of the online system based on the ranking comprises:
identifying a product of the set of products associated with the third party system as a candidate product based on the ranking; and
identifying additional products of the set of products as candidate products in response to identifying the product of the set of products as the candidate product.

12. The method of claim 10, wherein the set includes products associated with the third party system having one or more common characteristics.

13. The method of claim 1, wherein generating one or more versions of the content item from the one or more candidate products of the products associated with the third party system and the content item comprises:
responsive to not identifying at least one candidate product based on the ranking, withholding the content item from the one or more selection processes.

14. The method of claim 1, wherein selecting one or more versions of the content item based on the determined measures of relevance comprises:
associating a value with each version of the content item, the value associated with the version of the content item based on a determined measure of relevance of the version of the content item to the user; and
selecting each version of the content item.

15. The method of claim 14, wherein the one or more selection processes account for the values associated with each selected version of the candidate content item.

16. A computer program product comprising a computer readable storage medium having instructions encoded thereon that, when executed by a processor, cause the processor to:
obtain, at an online system, information from a third party system describing characteristics of one or more products associated with the third party system;
receive information identifying products accessed by a user of an online system;
receive a content item at the online system for presentation to one or more users of the online system, the content item including a creative presenting content describing a product of the one or more products associated with the third party system;
identify an opportunity to present one or more content items to the user of the online system;
rank the products associated with the third party system based on the received information identifying products accessed by the user of the online system and characteristics of the products associated with the third party system;
identify one or more candidate products of the products associated with the third party system for presentation to the user of the online system based on the ranking;
generate one or more versions of the content item from the one or more candidate products of the products associated with the third party system and the content item, each version of the content item having the creative including content describing a candidate product;
determine measures of relevance of each of the one or more versions of the content item to the user;
select one or more versions of the candidate content items based on the determined measures of relevance;
include the selected one or more versions of the content item in one or more selection processes selecting content for presentation to the user via the identified opportunity;
select a version of the content item including the creative including content describing one of the candidate products via the identified opportunity; and
communicate the selected version of the content item to a client device for presentation to the user.

17. The computer program product of claim 16, wherein rank the products associated with the third party system based on the received information identifying products accessed by the user of the online system and characteristics of the products associated with the third party system comprises:
determine likelihoods of the user interacting with at least a set of the products associated with the third party system based on the received information identifying products accessed by the user of the online system and characteristics of the products associated with the third party system; and
rank the products associated with the third party system based on the determined likelihoods.

18. The computer program product of claim 16, wherein rank the products associated with the third party system based on the received information identifying products accessed by the user of the online system and characteristics of the products associated with the third party system comprises:
rank the products associated with the third party system and products associated with other third party systems based on received information identifying products accessed by the user of the online system, characteristics of the products associated with the third party system comprises, and characteristics of the products associated with other third party systems.

19. The computer program product of claim 16, wherein the content item includes one or more characteristics of products to be described by the creative.

20. The computer program product of claim 19, wherein identify one or more candidate products of the products associated with the third party system for presentation to the user of the online system based on the ranking comprises:
identify products associated with the third party system having the one or more characteristics included in the content item and having at least a threshold position in the ranking.

21. The computer program product of claim 16, wherein select one or more versions of the candidate content items based on the determined measures of relevance comprises:
rank the one or more versions of the content item based on the determined measures of relevance; and
select versions of the content item having at least a threshold position in the ranking of the one or more versions of the content item.

22. The computer program product of claim 16, wherein generate one or more versions of the content item from the one or more candidate products of the products associated with the third party system and the content item comprises:
responsive to not identifying at least one candidate product based on the ranking, withhold the content item from the one or more selection processes.

23. The computer program product of claim 16, wherein select one or more versions of the content item based on the determined measures of relevance comprises:
associate a value with each version of the content item, the value associated with the version of the content item based on a determined measure of relevance of the version of the content item to the user; and
select each version of the content item.
